(19) United States
(12) Patent Application Publication
(10) Pub. No.: US 2007/0120875 A1
(43) Pub. Date: May 31, 2007

(54) Computer aided design interface

(75) Inventors: Mehmet Aygar, Elk Grove Village, IL (US); Gokboru Aygar, Elk Grove Village, IL (US)

Correspondence Address: THOMPSON HINE L.L.P., P.O. BOX 8801, DAYTON, OH, 45401-8801, US

(73) Assignee: Symons Corporation

(21) Appl. No.: 11/290,059

(22) Filed: Nov. 30, 2005

(51) Int. Cl. G09G 5/00

(52) U.S. Cl. 345/689

(57) ABSTRACT

In a CAD system, dimensions are entered as an arithmetic combination of quantities expressed in both English and metric units. The system converts the units and combines the quantities to produce the dimension. Also, an undo tool stores undo information in nonvolatile storage, so that drawing operations may be undone at any subsequent time, even after a file has been saved and retrieved, or transferred to another user. The system also associates drawn content with a paper size and orientation, rather than a specific printer, and associates each paper size and type with a printer, so that when printing a page, the paper size and type associated therewith can be used to select a printer. In this way, content may be printed on an appropriate printer based upon a paper size and orientation, without storing printer selections or details in the file.

### FIELD OF THE INVENTION

The present invention relates to computer automated design (CAD) systems and software and hardware therefor.

### BACKGROUND OF THE INVENTION

Computer automated design (CAD) systems have matured over the last several years, and now are used in nearly all design environments to speed the design process and increase its accuracy, benefitting both consumers and manufacturers. However, while these systems have been useful, their interfaces continue to be refined and improved, and certain difficulties with the use of such systems remain to be overcome.

For example, computer automated design systems are often used to design objects intended to be dimensionally matched to existing plans. One example is CAD software used to design architectural features that mate to an existing structure. One example of CAD software marketed for this purpose is the “DesignFast” product licensed by the assignee hereof to its customers, and intended for use in developing plans for concrete forms to be used in creating concrete walls. Other examples include an application known as Paschal Plan Light or PPL, marketed by Paschal Werk—G. Maier GmbH of Steinach, Germany, a program known as “Tipos”, available from the German form manufacturer Doka has and discussed at the Doka web site, http://www.doka.com/TiposDoka/index en.htm, and a product known as “Elpos” and available from Peri, www.peri.de.

A difficulty with CAD systems, such as those identified above, is that the designer often must develop a plan that uses existing structures or is compatible with existing structures. These existing structures may be dimensioned in multiple incompatible units, such as English units (yards, feet, inches) and/or metric units (meters, centimeters, millimeters), and the designer must then perform unit conversions to create compatibly dimensioned plans in the CAD system. Such unit conversions are difficult and introduce a likely source of human error.

One known solution to this difficulty, is to use a calculator or other special purpose device to perform unit conversions. For example, U.S. Pat. No. 4,860,233 shows a calculator designed to handle math operations on mixed English and Metric unit quantities, and inch—fractional foot and fractional inch—decimal inch conversions. Other patents in the general subject matter area include U.S. Pat. No. 4,336,653 (English unit to metric unit conversion device), U.S. Pat. No. 4,322,608 (Metric-English measurement comparator device), U.S. Pat. No. 4,282,514 (Electronic converter), and U.S. Pat. No. 4,228,516 (Computer for metric conversion).

Unfortunately, this known solution is not convenient for a designer using CAD software, as it requires the designer to utilize a device separate from the CAD system to perform unit conversions, and then enter the converted measurements into the CAD system, a process having a continuing risk of human error.

Another difficulty with existing CAD systems relates to the storage of designs and error recovery.

To protect from errors, many applications, including word processors and graphical editors, provide for an undo function. Thus, if a command is executed accidentally or incorrectly on content currently in memory, the command can be undone, returning the subject content to its state prior to execution of the command. In some applications, only the most recent command executed may be undone, whereas in others, all commands executed since a file was opened, or the since the file was last saved, can be undone. An example of such an undo function is described in U.S. Pat. No. 6,063,128, referencing FIG. 2 at col 10, line 49 et seq.

Many applications also provide for automatic data backup. Specifically, many applications will automatically save content currently in memory, so that in the event of a power failure or computer failure, there will be a saved copy of the content which can be used as a starting point to continue after the failure is corrected.

Unfortunately, these existing processes do not adequately protect against errors, for several reasons. First, the undo function has the limitation that erroneous commands may not be undone if they are outside the scope of the undo function, e.g., if the command is no longer on the application's undo queue, or the command was executed during a previous invocation of the application, after which the file was saved and the application closed, destroying undo information. In such cases, the only option available to a user is to manually undo a command, which can be tedious and subject to human error. In addition, functions for automatically saving content do not preserve all changes made, but only those changes made until the time of the most recent automatic backup was saved. Changes after the last automatic save are lost in the event of a failure. Furthermore, automatically saved content is typically deleted when an application is closed, so changes may be inadvertently lost if the application is inadvertently closed without saving changes made.

A further difficulty with known CAD systems, such as Acad, Micro station, Solid works, relates to the printing of content. Typically, printing device settings are embedded by CAD software into files created by the originating system. These settings are typically unique to a particular brand and model of printer, and as a consequence, when a file is transmitted from one user to another who has a different printing environment, often the file must be modified before it can be printed. The required changes may vary, including the plotter, file size, line/pen weight, B&W/Color/Grayscale settings, scale, and others. These settings may need to change for each page in a transferred file. In extreme cases, every page of a 99 page file will need modification before printing on the other user's system.

### SUMMARY OF THE INVENTION

The present invention addresses the difficulties with CAD systems discussed above, by its multiple aspects.

In one aspect, the invention features a computer aided design system and program product in which dimensions for drawing tools may be entered as an arithmetic combination of quantities expressed in both English and metric units. The system converts the units of the input quantities, and combines the converted quantities to produce a dimension in a common unit, thus greatly streamlining the process of creating a drawing and reducing the likelihood for human error.

In a second aspect, the invention features a computer aided design system having an undo tool that stores undo in a file in nonvolatile storage. The file contains a representation of each drawing tool invoked by the user, so that any and all drawing operations done on a file, may be undone based upon data in nonvolatile storage, at any subsequent time, even after a file has been saved and retrieved, or after a file has been transferred from one user to another.

In a third aspect, the invention features a computer aided design system and program product in which drawn content is associated with a paper size and orientation, rather than a specific printer. The system associates each paper size and type with a printer, so that when printing a page, the paper size and type associated therewith can be used to select a printer. In this way, content may be printed on an appropriate printer based upon a paper size and orientation, without storing printer selections or details in the file. This permits files to be printed by different users, having different printers, without requiring modification of the file.

The above and other objects and advantages of the present invention shall be made apparent from the accompanying drawings and the description thereof.

### BRIEF DESCRIPTION OF THE DRAWING

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 illustrates a computer aided design system in accordance with principles of the present invention;

FIG. 2 illustrates the screen displays on the CAD system of FIG. 1;

FIG. 3 illustrates a dimensional input window utilized by a parser in accordance with principles of the present invention;

FIG. 4 is a flow chart of the operations of the parser of the CAD system of FIG. 1;

FIG. 5 illustrates some of the data stored by the CAD system of FIG. 1;

FIG. 6 is a flow chart of the operations of the user interface of the CAD system of FIG. 1 when undoing and redoing drawing tool operations; and

FIG. 7 is a flow chart of the operations of the user interface of the CAD system of FIG. 1 when printing content.

### DETAILED DESCRIPTION OF SPECIFIC EMBODIMENTS

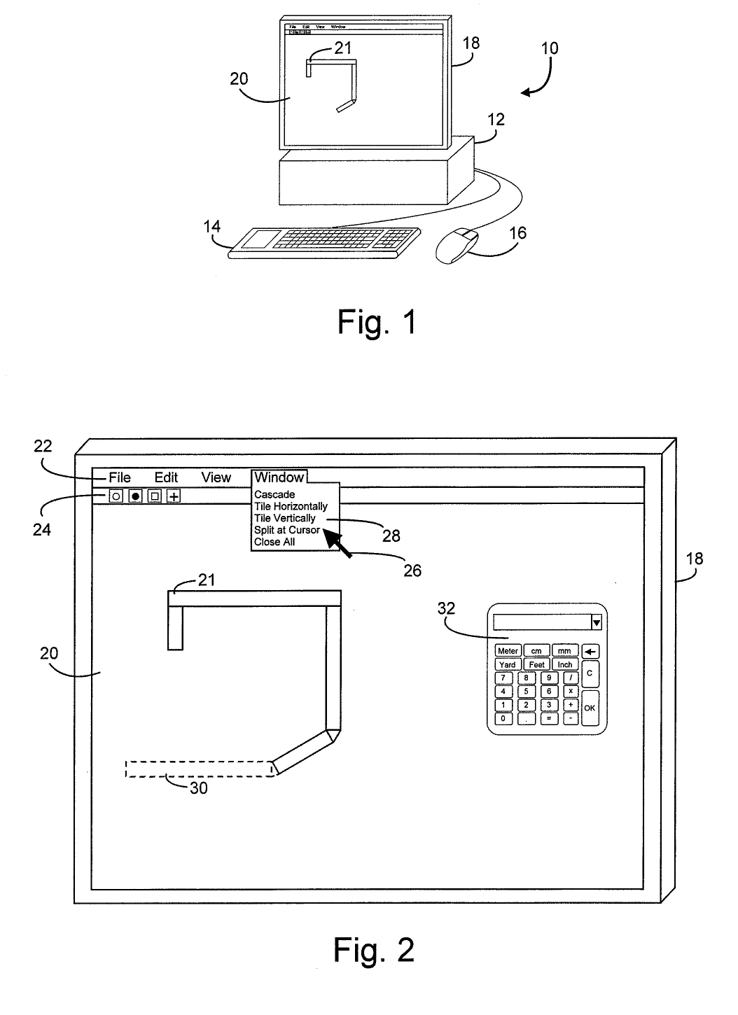

Referring now to FIG. 1, a computer aided design (CAD) system 10 in accordance with principles of the present invention comprises a software application operating on the CPU 12 of a general purpose computer such as a desktop computer system built around an Intel-compatible processor and the Microsoft Windows operating system. The application on the processor may be written in any number of source languages such as the C++ programming language.

It will be appreciated that the methods described here are computer implemented, but otherwise do not require any specific computerized implementation. Those skilled in the art will appreciate that the method and apparatus of the present invention apply equally to any computer system, regardless of whether the computer system is a complicated multi-user computing apparatus or a single user device such as a personal computer or workstation. Thus, the computer system used for the CAD system 10 can comprise IBM compatible personal computers running OS/2 or Microsoft's Windows, Apple compatible personal computers using Motorola or PowerPC processors, Linux or Unix compatible computers, or mainframe servers using Unix or another mainframe operating system.

The CPU 12 of the system 10 suitably comprises a processor, volatile memory such as DRAM, nonvolatile memory such as disk storage, and a user interface such as a graphics card, keyboard and mouse controller, all of which are interconnected via one or more system bus. Note that various modifications, additions, or deletions may be made to CAD system 10 illustrated in FIG. 1 within the scope of the present invention such as the addition of cache memory or other peripheral devices. FIG. 1 is presented to simply illustrate some of the salient features of an exemplary computer system 10.

The processor of the CPU 12 performs computation and control functions of CAD system 10. The processor may comprise a single integrated circuit, such as a microprocessor, or may comprise any suitable number of integrated circuit devices and/or circuit boards working in cooperation to accomplish the functions of a processor. The processor suitably executes a computer program within memory of the CPU 12.

The nonvolatile memory may be magnetic disks (e.g., hard disks or floppy diskettes) or optical storage devices (e.g., CD-ROM). One suitable storage device is a direct access storage device (DASD). In this application, the term “disk” will be used to collectively refer to all types of storage devices, including disk drives, optical drives, tape drives, etc.

It is important to note that while the present invention has been (and will continue to be) described in the context of a fully functional computer system, those skilled in the art will appreciate that the mechanisms of the present invention are capable of being distributed as a program product in a variety of forms, and that the present invention applies equally regardless of the particular type of signal bearing media to actually carry out the distribution. Examples of signal bearing media include: recordable type media such as floppy disks (e.g., a floppy disk) and CD ROMS, and transmission type media such as digital and analog communication links, including wireless communication links.

Referring now to FIG. 2, details of the user interface of a CAD system can be elaborated. The screen display includes a workspace 20 on which a drawing 21 is generated. As seen best in FIG. 2, the workspace resides in a display window, which includes therein various command functions for invoking drawing tools. These command functions may take the form of menu items in a menu 22 associated with the workspace 20, or may take the form of toolbar items on a toolbar 24 associated with the workspace 20. It will be appreciated that the commands available on menu 22 and/or toolbar 24 may be configurable by the user as appropriate for a particular application of the invention.

FIG. 2 illustrates the invocation of a drawing tool by the selction with a cursor 26 (controlled by mouse 16) of an item on menu bar 22, causing a pop-up menu 28 of commands to appear on workspace 20. By selection of a command on menu 28, a specific command may be executed.

In the illustration of FIG. 2, the executed command is to add a segment 30 to the drawing 21 being built in the workspace. This command requires the definition of the dimensions of the new segment 30, and for this purpose the execution of the command creates a dimensional input window 32 which appears in the workspace such as shown in FIG. 2.

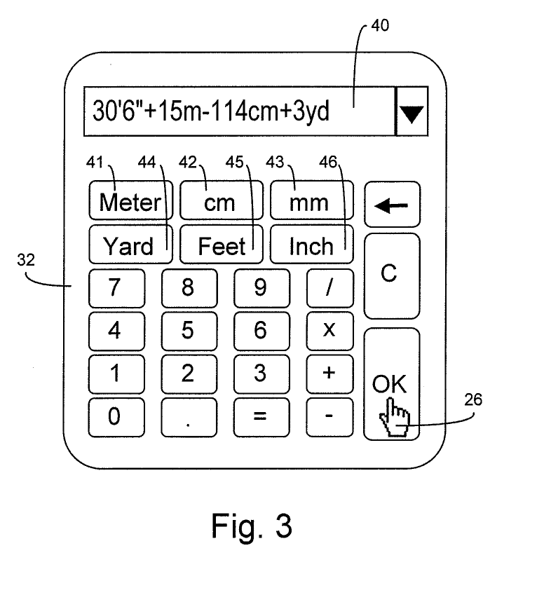

Details of the dimensional input window 32 may be seen in FIG. 3. There, it can be seen that window 32 includes virtual buttons for input of numeric information by the movement and clicking of the cursor 26 (which is modified to the appearance of a hand when over window 32). Also included in window 32 is a text box 40 where the user may enter text for the dimension requested by the drawing tool. As illustrated, the text entered in box 50 may a dimension as an arithmetic sum, difference, product or dividend of a number of dimensions, each of which may be defined in separate units. A dimensionless number appearing in text box 40 will be assumed to have a default unit, which may be selected by the user. However, numbers that are associated with a unit identifier, will be interpreted as having the identified unit, and will be converted to the default unit before the drawing tool performs the requested arithmetic operations.

Thus, in the example of FIG. 3, a dimension is defined as 30 feet six inches, plus 15 meters, minus 114 centimeters plus 3 yards. The drawing tool will convert this sum to a dimension in the default unit (e.g., meters), and then use the resulting dimension to define the new element 30 being created in the workspace.

As seen in FIG. 3, window 32 includes virtual buttons for creating dimension symbols. These include button 41 for meters (m), 42 for centimeters (cm), 43 for millimeters (mm), 44 for yards (yd), 45 for feet (′ or ft) and 46 for inches (in or ″). Virtual buttons 41-46 simplify the process for inputting dimensions, particularly if the user has difficulty remembering the symbol for a dimension or does not wish to use the keyboard to type the dimensional symbol into text box 40.

The parser that generates the display in FIG. 3 enables a designer to enter metric and English measurements as they are read from a plan, and perform basic arithmetic operations (addition, subtraction, multiplication, division) to draw structural drawings without the need of a unit converter. The parser accepts industry standard unit symbols and annotations, including ft and ′ for feet, in and ″ for inches, m for meters, cm for centimeters, yd for yards.

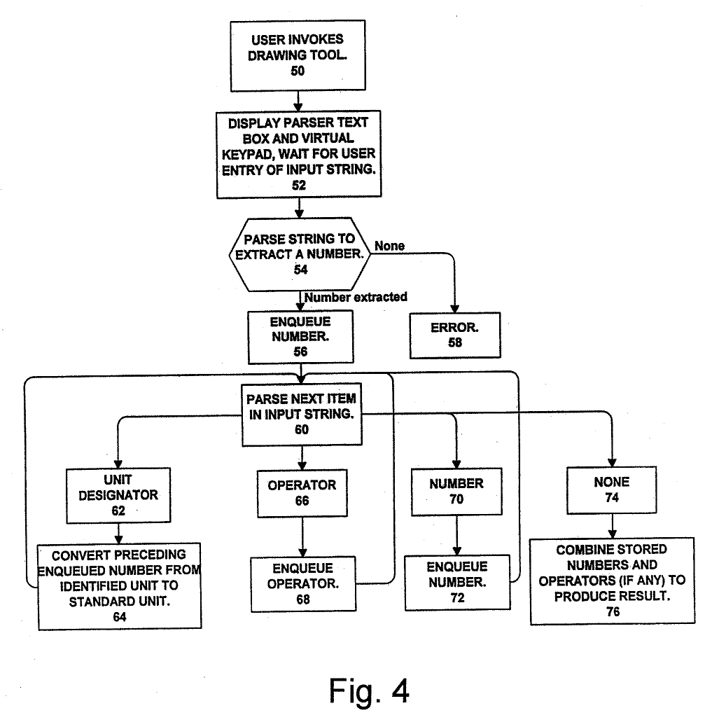

Referring now to FIG. 4, the process by which dimensions of different units are parsed and converted, may be explained. In a first step 50, the user invokes a drawing tool that requires the input of a dimension. Thereafter, in step 52, the parser text box 40 is displayed in window 32 (FIG. 3), along with the virtual keypad, and the user then enters an input string.

The first item in the input string should be a number, extracted at step 54 and enqueued at 56 (if a number is not the first item in the string, an error is returned 58. Then the next item in the input string is parsed at step 60.

If the next item is a unit designator (step 62), then the enqueued number is converted from the identified unit to the standard or default unit selected by the user, and processing returns to step 60 to parse the next item.

If the next item is an operator (*, +, −, /), (step 66), the operator is enqueued in step 68, and processing returns to step 60 to parse the next item.

If the next item is a number (step 70), then the number is enqueued and processing returns to step 60 to parse the next item.

Finally, if there are no further items (step 74), then processing proceeds to step 76, and the queued numbers (which have been converted to the standard unit), and the operators (if any) are evaluated to produce a result, which is the desired dimension for the invoked drawing tool.

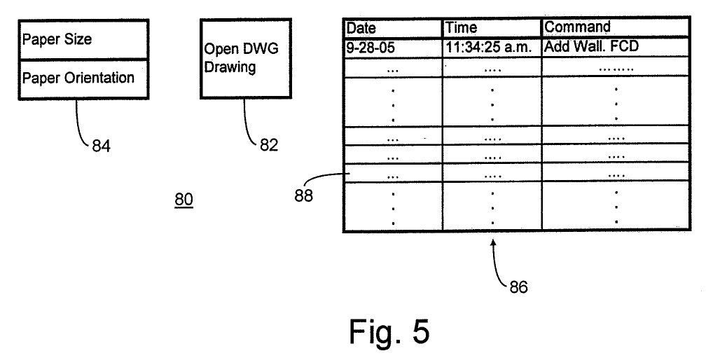

Referring now to FIG. 5, data stored by the CAD system of the present invention can be explained. It will be appreciated that the data shown in FIG. 5 may all be embedded in a single file for a drawing, or may be stored in multiple files of a suite of files relating to a particular drawing, both implementations being within the scope contemplated by the present invention.

As seen in FIG. 5, drawings are stored by the CAD system in a drawing file 82, using a drawing format, such as the Open DWG format promulgated by The DWG Alliance, now known as the Open Design Alliance, (www.opendesign.com). Open DWG is an “open” drawing file format, based on the DWG format licensed and popularized by Autodesk and its AutoCAD software. The DWG Alliance offers utilities at the above noted website, to convert Autodesk proprietary format files to OpenDWG and/or vice-versa.

Additional data stored by the CAD system includes paper size/paper orientation data 84 for a drawing file. The CAD system according to the present invention does not store detailed printer information associated with a drawing file. Rather, when a user creates a layout to be printed, only the size of the paper and its orientation (Landscape/Portrait) is stored. This data may be stored separately or embedded in the drawing file, as represented in FIG. 5.

The printer/plotter interface, described below, allows users to designate printers according to the sizes they print, thus removing allowing detailed printer information to be referenced separately from a drawing file.

To assign a printer to a specific paper size and orientation, the CAD system utilizes a Drag & Drop Interface. When a page is loaded for printing, the CAD system loads the installed printer/plotters into a listbox control. The user may then drag and drop printers (via mouse down events) from the list of printers to specific text box control associated with standard paper sizes, e.g., A/Letter/8.5×11, B/Ledger/Tabloid/11×17, Architectural/D/Poster/24×36, E/Poster/36×48. The system usefully focuses on standard paper sizes and types, streamlining printing, as compared to other CAD programs which attempt to support more paper sizes but by so doing introduces complexity that is normally unnecessary.

Thus, were a user to create a drawing file with 15 layout pages to be printed on D size paper, and 14 pages for Letter size and then print those pages, the CAD system would automatically identify the printer or plotter on which to print those pages, based upon the page sizes, without any modification to the files required. It is believed that existing drafting software lacks any similar function, and typically will require changes to printer/plotter settings within files to adapt those files to particular printers, before they can be printed.

FIG. 5 further illustrates an undo file 86 utilized by the CAD system. The CAD system of the present invention provides what is believed to be a novel function for editing drawing files. Specifically, the inventive approach provides lifelong access to each command executed by a user in creating a drawing, via the “Undo” function. Unlike other known drawing (and word processing applications), the CAD system of the present invention maintains undo information permanently, even when files are saved and retrieved, unless the user explicitly deletes undo information. Undo information is also accessible when a file created by a first user is transferred to a second user.

As shown in FIG. 5, each command that may be undone is saved in nonvolatile storage, such as on the hard drive of the CAD system. Each time user executes a command, the system automatically generates an entry in the undo file 86, identifying the state of the drawing file and the executed command, in the following format:
9,28,05; 11;34;25am; Add Wall.FCD (6);
In this format, the first field (6) indicates that this command is the 6th command executed by the user, 9,28,05 indicates the exact date the command was executed, 11;34;25 am indicates the exact time that this command is executed, and Add Wall FCD indicates the command executed by the user.

FIG. 5 illustrates an Undo file 86 having multiple records of commands that were sequentially invoked in the creation of the illustrated drawing file.

It will be noted that at any time, the current state of a drawing is associated with a specific current entry 88 in the commands stored in the undo file 86. The current entry 88 is frequently the last entry in the undo file 86, but need not be; if the user undoes a command, the current entry 88 is moved to entries prior to the last entry, corresponding to the drawing state seen by the user. If the user subsequently redoes undone commands with a “Redo” tool, the current entry 88 is moved toward the last entry, again corresponding to the drawing state seen by the user.

The Undo storage approach described here, and its advantages, are believed applicable to any software, not limited to CAD software. For example, word processing applications such as Word, WordPerfect and AmiPro, spreadsheet applications such as Excel, Quattro Pro or 1-2-3, presentation applications such as Powerpoint, and other applications may take advantage of an Undo function as described. In all such applications, due to carelessness or time pressure, it is likely that a user may not save work done, in which case an application crash or a power loss may lead to loss of the entire file. Even if the user has saved periodically, or has used an automatic 5 function of the application to save periodically, not all of the changes made will be preserved. In comparison, the technique described herein avoids the loss of any part of a project because each change is saved as it is made. The CAD system of the present invention thus protects the invested time of the user, providing unlimited undo capabilities even after closing and opening a file.

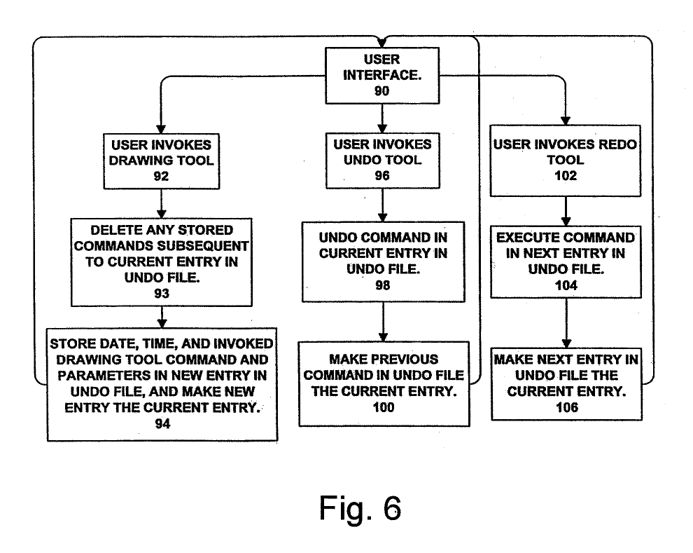

Referring now to FIG. 6, the use of the information shown in FIG. 5 may be elaborated. In a first step 90 in FIG. 6, the user invokes a function of the user interface. Specifically, the user may invoke 92 a drawing tool, in response to which a new entry in the undo file is created. Notably, if the current entry is not the last entry in the undo file, subsequent entries must be deleted. Thus, in a first step 93, any stored commands in entries subsequent to the current entry in the undo file are deleted. Then, in step 94, the date, time, and drawing tool command and its parameters are stored in a new entry the undo file 86.

After having used a drawing tool, the user may invoke 96 the undo tool, in which case the system undoes (step 98) the command identified in the current entry of the undo file. Note, however, that the undone command is not deleted, but is maintained in the undo file. Instead, in step 106, the previous command in the undo file is made current, thus maintaining the undone command for a possible later “redo” of that command.

If the user invokes 102 the redo tool, in step 104 the system redoes the last undone command, by executing the command identified in the next entry in the undo. Also, the next entry in the undo file is made the current entry, so that the current entry corresponds to the state of the content displayed to the user.

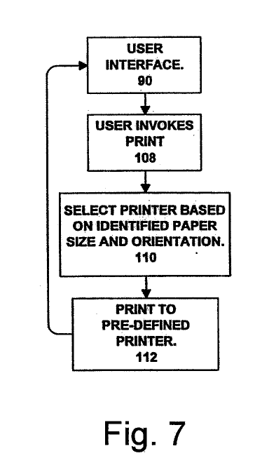

Referring now to FIG. 7, the process for printing from the user interface 90 can be elaborated. As noted above, if the user invokes 108 a print command, the CAD system selects (step 110) a printer based upon the identified paper size and orientation of each page of the current drawing, and in step 112, prints each page to the pre-defined printer for that paper size and/or orientation.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A computer aided design system comprising:
a drawing workspace for creating drawn content,
a plurality of drawing tools for creating shapes of objects in said drawing workspace, at least one of said drawing tools responding to at least one dimension to draw an object having said dimension in said drawing workspace, and
a parser for receiving said dimension for a said drawing tool, said parser receiving dimensions expressed as an arithmetic combination of quantities expressed in English and metric units, converting the units of said quantities and combining the converted quantities to produce a dimension in a common unit.

2. The computer aided design system of claim 1 wherein said parser comprises a text box for entry of said quantities and unit designators.

3. The computer aided design system of claim 1 wherein said parser recognizes numbers lacking unit designators as having a standard unit.

4. The computer aided design system of claim 1 wherein said parser recognizes units selected from the group comprising: meters, centimeters, inches, feet and yards.

5. A computer aided design program product, comprising an application executable on a computer system, the application implementing features comprising:
a drawing workspace for creating drawn content,
a plurality of drawing tools for creating shapes of objects in said drawing workspace, at least one of said drawing tools responding to at least one dimension to draw an object having said dimension in said drawing workspace, and
a parser for receiving said dimension for a said drawing tool, said parser receiving dimensions expressed as an arithmetic combination of quantities expressed in English and metric units, converting the units of said quantities and combining the converted quantities to produce a dimension in a common unit.

6. The computer aided design program product of claim 5 wherein said parser comprises a text box for entry of said quantities and unit designators.

7. The computer aided design program product of claim 5 wherein said parser recognizes numbers lacking unit designators as having a standard unit.

8. The computer aided design program product of claim 5 wherein said parser recognizes units selected from the group comprising: meters, centimeters, inches, feet and yards.

9. A computer aided design system comprising:
a drawing workspace for creating drawn content,
a plurality of drawing tools for creating shapes of objects in said drawing workspace, at least one of said drawing tools comprising an undo tool to reverse the effect of a previously executed drawing tool in said drawing workspace, wherein
said computer aided design system stores a representation of said drawn content in nonvolatile storage, and
said computer aided design system further stores, in an undo file in said nonvolatile storage, a representation of an invocation of a drawing tool performed by the system, said undo tool retrieving said representation from said nonvolatile storage, and utilizing said representation to reverse the effect of the represented invocation of the drawing tool,
whereby drawing tool invocations may be undone based upon data in nonvolatile storage regardless of the maintenance of undo information in volatile storage.

10. The computer aided design system of claim 9 wherein said computer aided design system further maintains, in said nonvolatile storage, a representation of an invocation of a drawing tool that has been undone by said undo tool.

11. The computer aided design system of claim 9 wherein said representation of said drawn content is in an OpenDWG format.

12. The computer aided design system of claim 9 wherein said undo file is stored separately from said representation of said drawn content.

13. A computer aided design program product, comprising an application executable on a computer system, the application implementing features comprising:
a drawing workspace for creating drawn content,
a plurality of drawing tools for creating shapes of objects in said drawing workspace, at least one of said drawing tools comprising an undo tool to reverse the effect of a previously executed drawing tool in said drawing workspace, wherein
said computer aided design program product stores a representation of said drawn content in nonvolatile storage, and
said computer aided design program product further stores, in an undo file in said nonvolatile storage, a representation of an invocation of a drawing tool performed by the program product, said undo tool retrieving said representation from said nonvolatile storage, and utilizing said representation to reverse the effect of the represented invocation of the drawing tool,
whereby drawing tool invocations may be undone based upon data in nonvolatile storage regardless of the maintenance of undo information in volatile storage.

14. The computer aided design program product of claim 13 wherein said computer aided design program product further stores, in said nonvolatile storage, a representation of an invocation of a drawing tool that has been undone by said undo tool.

15. The computer aided design program product of claim 13 wherein said representation of said drawn content is in an OpenDWG format.

16. The computer aided design program product of claim 13 wherein said undo file is stored separately from said representation of said drawn content.

17. A computer aided design system comprising:
a drawing workspace for creating drawn content,
a plurality of drawing tools for creating shapes of objects in said drawing workspace, at least one of said drawing tools comprising a printing tool to print content in said drawing workspace, wherein
said computer aided design system stores a representation of paper size and orientation for said drawn content in nonvolatile storage, and
said computer aided design system associates a paper size and type with a printer,
wherein said printing tool utilizes a paper size and type for drawn content to select a printer associated therewith,
whereby content may be printed on an appropriate printer based upon a paper size and orientation without requiring separate selection of a printer therefor.

18. The computer aided design system of claim 17 wherein said representation of said drawn content is in an OpenDWG format.

19. The computer aided design system of claim 17 wherein said representation of paper size and orientation is stored separately from said representation of said drawn content.

20. A computer aided design program product, comprising an application executable on a computer system, the application implementing features comprising:
a drawing workspace for creating drawn content,
a plurality of drawing tools for creating shapes of objects in said drawing workspace, at least one of said drawing tools comprising a printing tool to print content in said drawing workspace, wherein
said computer aided design program product stores a representation of paper size and orientation for said drawn content in nonvolatile storage, and
said computer aided design program product associates a paper size and type with a printer,
wherein said printing tool utilizes a paper size and type for drawn content to select a printer associated therewith,
whereby content may be printed on an appropriate printer based upon a paper size and orientation without requiring separate selection of a printer therefor.

21. The computer aided design program product of claim 20 wherein said representation of said drawn content is in an OpenDWG format.

22. The computer aided design program product of claim 20 wherein said representation of paper size and orientation is stored separately from said representation of said drawn content.
